(19) United States
(12) Patent Application Publication
(10) Pub. No.: US 2007/0221559 A1
(43) Pub. Date: Sep. 27, 2007

(54) Sterilizing pot for a water purifier

(76) Inventor: Wei-jen Wang, Tai-shan Hsieng (CN)

Correspondence Address: LADAS & PARRY, 5670 WILSHIRE BOULEVARD, SUITE 2100, LOS ANGELES, CA, 90036-5679, US

(21) Appl. No.: 11/726,845

(22) Filed: Mar. 23, 2007

(30) Foreign Application Priority Data
Mar. 27, 2006 (TW) 095205061

(51) Int. Cl. C02F 1/48

(52) U.S. Cl. 210/222

(57) ABSTRACT

A sterilizing pot comprises a main frame and a pot with an outlet and an inlet for containing related elements. The inside of the pot is constructed with a magnetizing unit and a UV sterilizing lamp. The magnetizing unit further includes a condensed carbonized healthy stone and a far infrared magnetic hose. The condensed carbonized healthy stone is employed for mineralizing the water, and the far infrared magnetic hose can make the water molecular finer. The carbonized healthy stone and the far infrared magnetic hose are used in cooperation with the UV sterilizing lamp for killing bacteria and/or viruses, to enable the water molecules to be absorbed easily by the human body, and to improve anti-bacteria efficiency.

### CROSS-REFERENCE TO RELATED APPLICATIONS

This application claims the priority of Taiwanese patent application no. 095205061 for “The Sterilizing Pot for the Water Purifier” filed on Mar. 27, 2006.

### BACKGROUND

This application relates to a sterilizing pot for a water purifier, and the object is to provide a filtering pot structure which can enhance effectively the sterilizing efficiency of the water purifier and make water molecules easier to be absorbed by the human body.

Water source pollution resulting from industrial development, the old pipe lines in water distribution systems, and ill-maintenance of water-storage facilities cause drinking water being exposed to potential organic or inorganic contaminants. Consequently, the people have doubts and concerns about the safety of the drinking water. Even after water treatment in a water purifying plant, the water flowing out of faucets may contain heavy metals from within the pipe line and pesticides or germs from nearby ground may flow into the water source. These floating particles or contaminants may invade directly into your body through the water you drink.

Besides, the water percentage in human body is more than sixty percent, and its main function is to transport nutrients and essential chemical substances into and out of the cells; thus water can maintain the skin moist, keep the brain work properly, adjust the body temperature effectively, and help to delay aging. The significance of water to the human body is beyond imagination. Therefore, it is a trend to improve the water quality by using a water purifier in order to protect the safety and health of the user and the user's family. Currently, most conventional water purifiers on the market belong to passive filtering apparatuses. They merely employ filters to filter out and remove the impurities, particles and contaminants present in the water. Not only can filters not sterilize water completely, but also they can not improve the water quality.

### SUMMARY

In the light of the above drawbacks, the present disclosure provides a sterilizing structure which effectively enhances efficiency of sterilizing and bacteria-killing and makes the water molecules more easily absorbed by the human body. The filtering pot comprises a main frame with an outlet and inlet for containing related components; the inside of the pot is constructed with magnetizing unit and UV lamp. The magnetizing unit further includes condensed carbonized healthy stone and far infrared magnetic hose; the condensed carbonized healthy stone is used for water mineralization, and the water molecular is more refined under the operation of the far infrared magnetic hose. It cooperates with the UV sterilizing lamp for killing bacteria and filtering out virus, and makes the water molecules to be absorbed easier by human body, and enhance the bactericidal efficiency.

Furthermore, in an aspect of the sterilizing structure, a top base and a spiral cover are set on the top opening of the pot, and the spiral cover seals the top base on the opening on top of the pot, an inlet is set up on the side portion of the pot, an outlet is set up on the top base. The condensed carbonized healthy stone of the magnetizing unit is set up in the area corresponding to the inlet through an assembling case; a tube is set up in the center portion of the top base and passes through the assembling case and extends downward, the UV lamp is set up within the tube, and the far infrared magnetic hose of the magnetizing unit is connected between the bottom of the assembling case and the tube. The water flowing through the inlet and into the pot first flows into the assembling case, and infiltrates downward through the condensed carbonized healthy stone and passes through the far infrared magnetic hose into the tube and upward into the top base, and finally drained out of the pot through the outlet. Therefore, the water can be totally under the function of the magnetizing unit and UV sterilizing lamp to ensure the water flowing out of the filtering pot is safe and sterile.

### BRIEF DESCRIPTION OF THE DRAWINGS

FIG. 1 is a perspective view of a preferred embodiment of the sterilizing pot of the present application.

FIG. 2 is an exploded view of the sterilizing filtering pot of FIG. 1.

FIG. 3 is a perspective view of the sterilizing filtering pot of FIG. 1.

FIG. 4 is an exploded view of a water purifier showing the connection between the sterilizing filtering pot of FIG. 1 and other filtering and purifying pots of the water purifier.

### DESCRIPTION OF THE NUMBERS OF THE MAIN COMPONENTS OF SPECIFIC EMBODIMENT

10 sterilizing pot
11 pot
111 top base
112 spiral cover
113 inlet
114 outlet
115 tube
12 magnetizing unit
121 condensed carbonized healthy stone
122 far infrared magnetic hose
123 assembling case
13 UV sterilizing lamp
20 water purifier
21 filtering pot
22 purifying pot
23 control circuit

### DESCRIPTION OF SPECIFIC EMBODIMENT

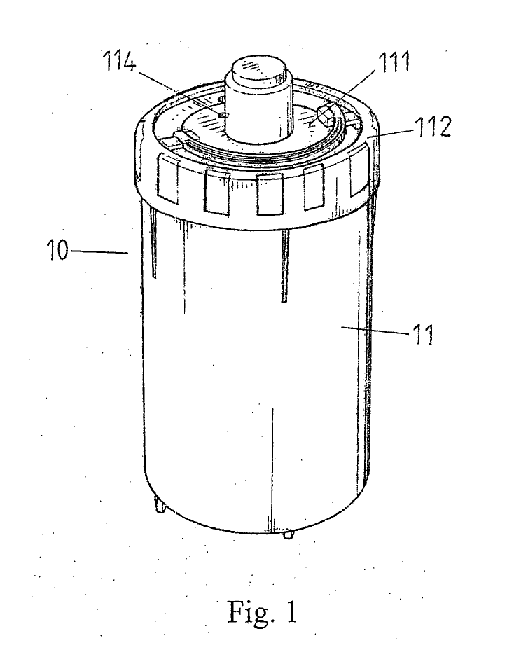

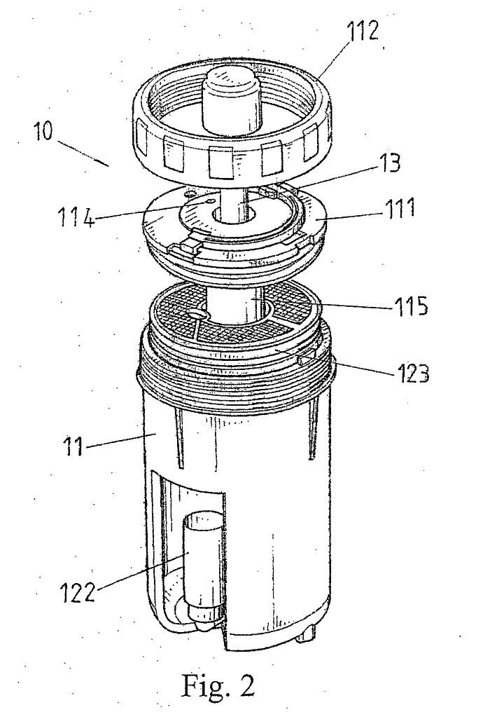

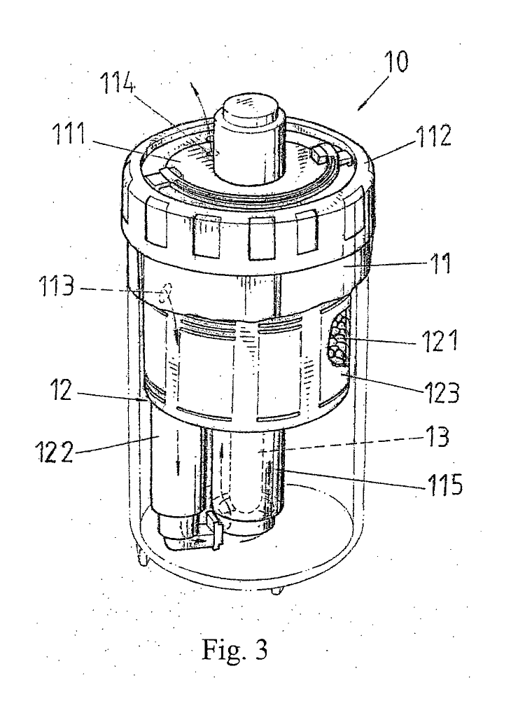

The basic structure of a preferred embodiment of a sterilizing pot of the present application is shown in FIG. 1-3. The pot 11 with an outlet 114 and an inlet 113 functions as a main body for accommodating related components. The interior of the pot 11 is constructed with a magnetizing unit 12 and a UV sterilizing lamp. The magnetizing unit 12 further comprises a condensed carbonized healthy stone 121 and a far infrared magnetic hose 122. The condensed carbonized healthy stone 121 mineralizes the water, and the far infrared magnetic hose 122 makes the water molecules to be finer.

A top base 111 and a spiral cover 112 are set on the top opening of the pot 11, and the spiral cover 112 seals and presses the top base 111 on the top opening of the pot. An inlet 113 is set up on the side portion of the pot 11, and an outlet 114 is set up on the top base 111. The condensed carbonized healthy stone 121 of the magnetizing unit 12 is set up in the area corresponding to the inlet 113 through the assembling case 123. A tube 115 is set up in the center portion of the top base 111 and passes through the assembling case 123 and extends downward. The UV lamp 13 is set up within the tube 115, the far infrared magnetic hose 122 of the magnetizing unit 12 is in beehive shape, and is connected between the bottom of assembling case 123 and the tube 115.

The water flowing through the inlet 113 and into the pot 11 first flows into the assembling case 123, and infiltrates downward through the condensed carbonized healthy stone 121 and passes through the far infrared magnetic hose 122 into the tube 115 and upward into the top base 111, and finally drained out of the pot 11 through the outlet 114; therefore, the water can be totally under the function of the magnetizing unit 12 and the UV lamp 13 to ensure the water purifier release safe, bacteria-free drinking water.

During utilization, the condensed carbon healthy stone 121 can release more than thirty essential minerals required by human body to achieve the purpose of water mineralization. Those minerals belong to ionized minerals which are absorbed most easily by the human body, and it can turn acid water into slightly alkaline water suitable for human body. It neutralizes/washes the acid toxins in the human body through mineral-containing slightly alkaline water. The bacteria in the water are killed by the UV lamp 43, and filter out more than 99% of viruses to ensure the water purifier release bacterial-free and virus-free clean water. The far infrared magnetic hose 122 is in a beehive shape, which can generate an magnetic field of, for example, 8800-gauss to achieve the purpose of water magnetization and finer water molecules. Moreover, it makes the water molecules structure in a hexagon structure with orderly alignment which is compatible with the water molecules in the human body and is absorbed more easily by human body.

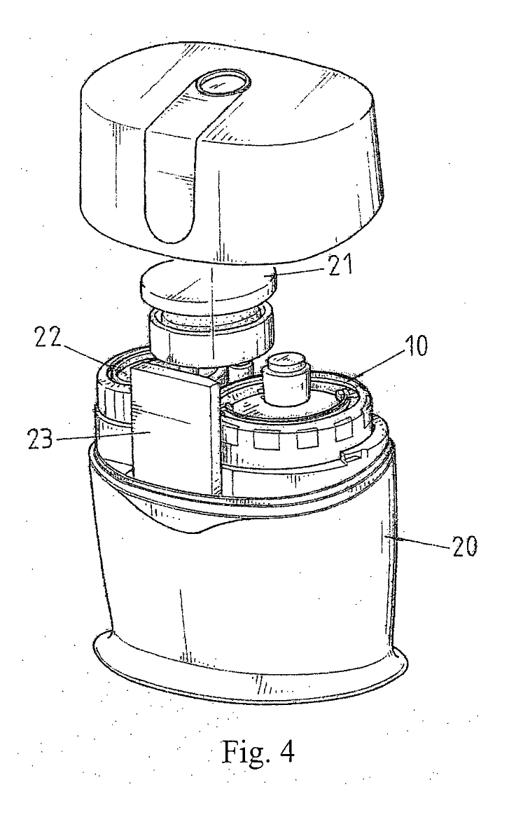

The sterilizing pot 10 can be connected with water supply pipes of drinking water through only the inlet 13 of the pot 11, and the processed sterilized water is connected to the related water output devices through the outlet 14 of the pot 11 so that the pot 11 becomes a high-efficient bactericidal water purifier. Certainly, as shown in FIG. 4, connecting the pot 11 of the sterilizing pot 10 to the filtering pot 21 and the purifying pot 22 of the water purifier 20 to become one component of the water purifier 20 and form a complete water purifying process. A suitable water purifier is described in my co-pending U.S. application for a “Water Purifier,” incorporated herein by reference, which application claims the priority of Taiwanese patent application no. 095110494 for “Water Purifier” filed on Mar. 27, 2006.

Particularly, under the monitor of the control circuit 23 of the water purifier 20, the UV lamp 13 in the sterilizing pot 10 is intermittently turned on under normal condition for a period of time (for example, the UV lamp will be automatically turned on to kill the bacteria after three hours off). The UV lamp is turned on at all times during water utilization, and is connected to a digital electronic flux meter (not shown in FIG. 4). Not only does it compute the water amount in a single usage and accumulative water usage amount to reflect the remaining life time of the sterilizing pot 10, but also it can calculate the actual water flux, so the control circuits 23 can adjust the radiation intensity of the UV lamp based on the water flux to achieve the effect of energy saving and ensure the water in the filtering pot is bacterial free.

As described above, the present application provides a preferable sterilizing pot structure. However, the above description and the drawings depict a preferred embodiment of the present application, and should not be considered for purposes of limiting the new application. Therefore, all structures, devices and features similar to the present application all belong to the scope of the application as defined in the appended claims.

I claim:

1. A sterilizing pot for a water purifier comprising:
a pot configured with an outlet and an inlet for containing associated components as a main body;
a magnetizing unit constructed within said pot for water mineralization and to make water molecules finer; and
a UV sterilizing lamp constructed within said pot for killing bacteria and virus in said water.

2. The sterilizing pot of claim 1, wherein said magnetizing unit comprises a condensed carbonized healthy stone and a far infrared magnetic hose.

3. The sterilizing pot of claim 2, wherein a top base and a spiral cover are configured at the top opening of said pot, said spiral cover seals said top base, said inlet is set on the side portion of said pot, and said outlet is set on the top base, wherein said condensed carbon healthy stone of said magnetizing unit is assembled in the area corresponding to the inlet; a tube which passes through an assembling case and extends downward is configured in the center of said top base, wherein said UV lamp is configured within said tube, and said far infrared magnetic hose of said magnetic unit being connected between the bottom of said assembling case and said tube.

4. The sterilizing pot of claim 2, wherein said far infrared magnetic hose is in a beehive shape.

5. The sterilizing pot of claim 3, wherein said far infrared magnetic hose is in a beehive shape.

6. The sterilizing pot of claim 1, wherein said UV sterilizing lamp under normal conditions is turned on intermittently for a period of time to kill bacteria, and wherein said UV sterilizing lamp is on all the time during water utilization and the radiation intensity of said UV ray is adjusted based on said water flux.
